(19) United States
(12) Patent Application Publication
(10) Pub. No.: US 2024/0084500 A1
(43) Pub. Date: Mar. 14, 2024

(54) DESICCANT-BASED LAUNDRY DRYERS

(71) Applicant: Samsung Electronics Co., Ltd., Suwon-si (KR)

(72) Inventors: Guolian Wu, Saint Joseph, MI (US); Raveendran Vaidhyanathan, Rockaway, NJ (US)

(21) Appl. No.: 18/507,732

(22) Filed: Nov. 13, 2023

Related U.S. Application Data
(63) Continuation-in-part of application No. 17/971,545, filed on Oct. 21, 2022.
(60) Provisional application No. 63/530,233, filed on Aug. 1, 2023.
(60) Provisional application No. 63/346,535, filed on May 27, 2022.

(51) Int. Cl. D06F 58/20; B01D 53/04; D06F 39/04; D06F 58/24; D06F 58/26

(52) U.S. Cl. CPC D06F 58/206; B01D 53/0438; B01D 53/0446; D06F 39/04; D06F 58/24; D06F 58/26; B01D 2257/80; B01D 2259/4009

(57) ABSTRACT

An apparatus includes a dryer having a dryer drum configured to receive laundry items to be dried during a drying cycle. The apparatus also includes a desiccant reservoir having a desiccant configured to remove moisture in air from the dryer drum during the drying cycle. The apparatus further includes a heat pump configured to regenerate the desiccant in the desiccant reservoir for use during a subsequent drying cycle. The heat pump includes a condenser configured to condense a refrigerant, an evaporator configured to evaporate the condensed refrigerant, and a compressor configured to compress the evaporated refrigerant and provide the compressed refrigerant to the condenser.

### CROSS-REFERENCE TO RELATED APPLICATIONS AND PRIORITY CLAIM

This application claims priority under 35 U.S.C. § 120 as a continuation-in-part of U.S. patent application Ser. No. 17/971,545 filed on Oct. 21, 2022, which claims priority under 35 U.S.C. § 119(e) to U.S. Provisional Patent Application No. 63/346,535 filed on May 27, 2022, both of which are hereby incorporated by reference in their entirety. This application also claims priority under 35 U.S.C. § 119(e) to U.S. Provisional Patent Application No. 63/530,233 filed on Aug. 1, 2023, which is hereby incorporated by reference in its entirety.

### TECHNICAL FIELD

This disclosure generally relates to laundry devices and, more particularly, to desiccant-based laundry dryers.

### BACKGROUND

Drying laundry can require significant amounts of energy. For example, a standard Department of Energy (DOE) energy test involves a single load of wet clothes that includes 8.45 pounds of dry clothes weight and 4.48 pounds of water contained in the wet clothes. A known electric clothes dryer can use a minimum of 1.28 kWh of heat to dry the clothes by evaporating the 4.48 pounds of water. With a heat loss of 0.64 kWh (meaning a thermal efficiency of 67%), a total of 1.92 kWh of thermal energy would be needed as energy input to dry the clothes. This 0.64 kWh heat, loss is thermal energy that is dissipated to ambient air, the dryer structure, and air that is discharged (exhausted) to ambient air (such as outdoors). Additionally, a fan and motor assembly may consume additional energy of 0.35 kW, which results in a total energy consumption for the single load to be 2.27 kWh. This results in a final combined energy factor (CEF) of 3.73 lbs/kWh (8.45 lbs/2.27 kWh=3.73 lbs/kWh). In the United States alone, an estimated $9 billion per year is spent on energy costs for drying clothes, which represents about six percent of annual residential electricity consumption. On average, clothes dryers use approximately 1.95 kWh per load, 46 kWh per month, and 551.6 kWh per year (based upon an assumption of 283 cycleslyear).

### SUMMARY

This disclosure relates to desiccant-based laundry dryers.

In a first embodiment, an apparatus includes a dryer having a dryer drum configured to receive laundry items to be dried during a drying cycle. The apparatus also includes a desiccant reservoir having a desiccant configured to remove moisture in air from the dryer drum during the drying cycle. The apparatus further includes a heat pump configured to regenerate the desiccant in the desiccant reservoir for use during a subsequent drying cycle. The heat pump includes a condenser configured to condense a refrigerant, an evaporator configured to evaporate the condensed refrigerant, and a compressor configured to compress the evaporated refrigerant and provide the compressed refrigerant to the condenser.

Any single one or any suitable combination of the following features may be used with the first embodiment. The heat pump may also include a secondary heat pump loop having (i) a secondary condenser coupled to the compressor using a first three-way valve and (ii) a secondary evaporator coupled to the compressor using a second three-way valve. During the drying cycle, (i) the first three-way valve may be configured to couple the condenser and the secondary condenser and (ii) the second three-way valve may be configured to couple the evaporator and the secondary evaporator. During the regeneration of the desiccant in the desiccant reservoir, (i) the first three-way valve may be configured to couple the compressor and the condenser and (ii) the second three-way valve may be configured to couple the compressor and the evaporator. The secondary condenser may be configured to increase an inlet temperature to the dryer drum during the drying cycle, and the secondary evaporator may be configured to decrease a temperature of the desiccant reservoir during the drying cycle. The apparatus may also include a first fan configured to direct air from the desiccant reservoir into the dryer drum during the drying cycle and a second fan configured to direct air from the heat pump into the desiccant reservoir during the regeneration of the desiccant in the desiccant reservoir. The first fan may be configured to be turned off during the regeneration of the desiccant in the desiccant reservoir. The second fan may be configured to be turned off during the drying cycle. The heat pump may be configured to at least partially regenerate the desiccant in the desiccant reservoir after the drying cycle ends and before the subsequent drying cycle begins. The heat pump may have a coefficient of performance of at least two.

In a second embodiment, an apparatus includes a dryer having a dryer drum configured to receive laundry items to be dried during a drying cycle. The apparatus also includes a desiccant reservoir having a desiccant configured to remove moisture in air from the dryer drum during the drying cycle. The apparatus further includes a first fan configured to direct ambient or outdoor air over or through the desiccant in the desiccant reservoir to regenerate the desiccant in the desiccant reservoir for use during a subsequent drying cycle.

Any single one or any suitable combination of the following features may be used with the second embodiment. The desiccant reservoir and the first fan may be positioned in a base of the dryer. The apparatus may also include a heater configured to heat the ambient or outdoor air, and the desiccant reservoir may be configured to receive the heated air. During the drying cycle, the heater may be configured to not heat the ambient or outdoor air. During a first portion of the regeneration of the desiccant in the desiccant reservoir, the heater may be configured to not heat the ambient or outdoor air. During a second portion of the regeneration of the desiccant in the desiccant reservoir, the heater may be configured to heat the ambient or outdoor air. The apparatus may also include a second fan configured to direct air from the desiccant reservoir into the dryer drum during the drying cycle. The first fan may be configured to be turned off during the drying cycle. The second fan may be configured to be turned off during the regeneration of the desiccant in the desiccant reservoir.

In a third embodiment, an apparatus includes a dryer having a dryer drum configured to receive laundry items to be dried during a drying cycle. The apparatus also includes a desiccant reservoir having a desiccant configured to remove moisture in air from the dryer drum during the drying cycle. The apparatus further includes a ventilation line coupled to the desiccant reservoir and configured to be coupled to an external appliance. The ventilation line is configured to transport heated air from the desiccant reservoir to the external appliance for use during regeneration of the desiccant in the desiccant reservoir.

Any single one or any suitable combination of the following features may be used with the third embodiment. The ventilation line may be configured to be coupled to a washing machine such that the heated air is able to heat water in the washing machine. The ventilation line may be configured to be coupled to a heat exchanger associated with one of: a hot water tank, a dishwasher, or a washing machine. The apparatus may also include a fan configured to direct ambient or outdoor air over or through the desiccant in the desiccant reservoir to regenerate the desiccant in the desiccant reservoir for use during a subsequent drying cycle. The apparatus may also include a fan configured to direct the heated air from the desiccant reservoir to the external appliance. The apparatus may also include a heater configured to heat air from the external appliance, and the desiccant reservoir may be configured to receive the heated air. During the drying cycle, the heater may be configured to not heat the air from the external appliance. During a first portion of the regeneration of the desiccant in the desiccant reservoir, the heater may be configured to not heat the air from the external appliance. During a second portion of the regeneration of the desiccant in the desiccant reservoir, the heater may be configured to heat the air from the external appliance.

Other technical features may be readily apparent to one skilled in the art from the following figures, descriptions, and claims.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example desiccant-based laundry dryer supporting heat pump-based desiccant regeneration in accordance with this disclosure;

FIG. 2 illustrates another example desiccant-based laundry dryer supporting heat pump-based desiccant regeneration in accordance with this disclosure;

FIG. 3 illustrates an example method for using a desiccant-based laundry dryer supporting heat pump-based desiccant regeneration in accordance with this disclosure;

FIG. 4 illustrates an example desiccant-based laundry dryer supporting air-based desiccant regeneration in accordance with this disclosure;

FIG. 5 illustrates another example desiccant-based laundry dryer supporting air-based desiccant regeneration in accordance with this disclosure;

FIG. 6 illustrates an example method for using a desiccant-based laundry dryer supporting air-based desiccant regeneration in accordance with this disclosure;

FIG. 7 illustrates an example desiccant-based laundry dryer supporting external appliance-based desiccant regeneration in accordance with this disclosure;

FIG. 8 illustrates another example desiccant-based laundry dryer supporting external appliance-based desiccant regeneration in accordance with this disclosure;

FIG. 9 illustrates an example method for using a desiccant-based laundry dryer supporting external appliance-based desiccant regeneration in accordance with this disclosure; and

FIG. 10 illustrates an example controller for use with a desiccant-based laundry dryer in accordance with this disclosure.

### DETAILED DESCRIPTION

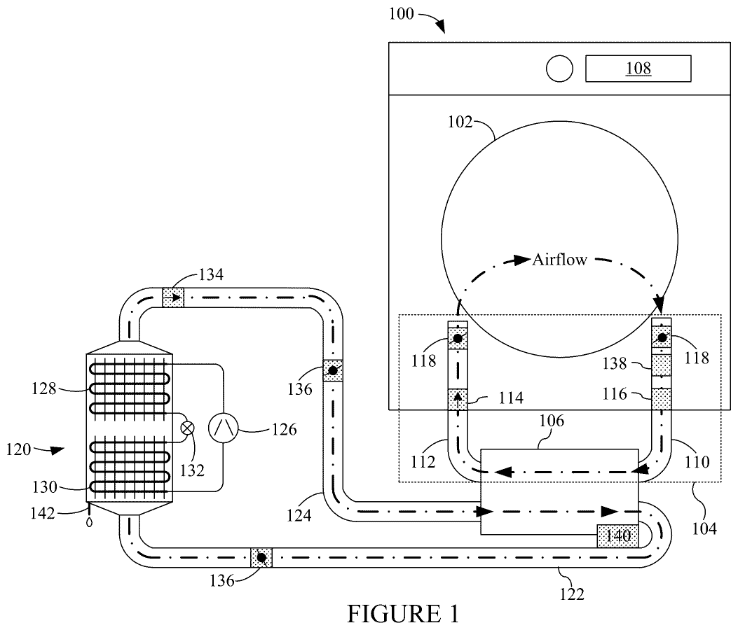

FIGS. 1 through 10, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

While the disclosure concludes with claims defining novel features, it is believed that the various features described herein will be better understood from a consideration of the description in conjunction with the drawings. The process(es), machine(s), manufacture(s), and any variations thereof described within this disclosure are provided for purposes of illustration and are not intended to be exhaustive or limited to the form and examples disclosed. The terminology used herein was chosen to explain the principles of the inventive arrangements, the practical application or technical improvement over technologies found in the marketplace, and/or to enable others of ordinary skill in the art to understand the embodiments disclosed herein. Further, the terms and phrases used within this disclosure are not intended to be limiting but rather to provide an understandable description of the features described. Any specific structural and functional details described are not to be interpreted as limiting but merely as a basis for the claims and as a representative basis for teaching one skilled in the art to variously employ the features described in virtually any appropriately detailed structure.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

This disclosure provides various desiccant-based laundry dryers. Each of the desiccant-based laundry dryers utilizes a desiccant to dry laundry items, and each of the desiccant-based laundry dryers incorporates at least one energy-efficient technique to regenerate the desiccant (instead of relying only on an electrical heater). Various examples of energy-efficient regeneration techniques are provided below and may include heat pump-assisted desiccant regeneration, desiccant regeneration using ambient (indoor) air and/or outdoor air, desiccant regeneration using indoor or outdoor air with the assistance of an electrical heater, and hybrid desiccant regeneration using an external appliance (such as a washing machine or heat exchanger). These regeneration techniques can reduce the energy consumption needed for desiccant regeneration, which can increase the combined energy factor (CEF) of the desiccant-based laundry dryers. Certain embodiments of the desiccant-based laundry dryers may also operate as stand-alone systems and do not require coordination with other devices to achieve high energy efficiencies.

FIG. 1 illustrates an example desiccant-based laundry dryer 100 supporting heat pump-based desiccant regeneration in accordance with this disclosure. As shown in FIG. 1, the dryer 100 includes a dryer drum 102 and a dryer ventilation line 104. A desiccant reservoir 106 is coupled to the dryer ventilation line 104. The desiccant reservoir 106 may be included as part of the dryer 100 or as a separate subsystem used by or with the dryer 100. In some cases, the desiccant reservoir 106 may be positioned in a base of the dryer 100.

The dryer 100 is configured to implement a drying cycle where the dryer 100 is activated (turned on) and a load of laundry (such as wet clothes, towels, etc.) is loaded into the dryer drum 102 of dryer 100. The dryer 100 includes a controller 108. Using the controller 108, certain settings of the dryer 100 can be selected that determine the amount of time that the dryer 100 is to be operated or the amount of dryness to be achieved by the dryer 100. These settings can be used to determine when the drying cycle ends.

Air from the dryer drum 102 is circulated, via the dryer ventilation line 104, over or through the desiccant reservoir 106 and eventually back to the dryer drum 102. The dryer ventilation line 104 includes a dryer air output line 110 that connects the dryer drum 102 to the desiccant reservoir 106 and conveys air out from the dryer drum 102. The dryer ventilation line 104 also includes a dryer air input line 112 that connects the desiccant reservoir 106 to the dryer drum 102 and conveys air into the dryer drum 102. The term “ventilation line” generally refers to any suitable pathway used to circulate air or to move air from one location to another, such as one or more air ducts, tubes, pipes, etc.

The dryer 100 is not limited to any particular device used to drive air through the dryer ventilation line 104. However, in some embodiments, one or more fans 114, such as one or more mechanical fans, may be used. The dryer 100 is also not limited to any particular type of fan 114. For example, the one or more fans 114 may be implemented as one or more axial flow fans or centrifUgal fans, In some cases, the one or more fans 114 may be implemented as one or more fan/motor assemblies. In other cases, the one or more fans 114 may be driven by the same motor that drives the dryer drum 102. In addition, the dryer 100 is not limited to any particular location(s) of the fan(s) 114 within the dryer ventilation line 104. For instance, a fan 114 can be located upstream and/or downstream of the desiccant reservoir 106. In some embodiments, the fan 114 is located downstream from the desiccant reservoir 106, such as when the fan 114 is disposed in/on the dryer air input line 112. In so doing, the fan 114 may be exposed to lower humidity as compared to an implementation where the fan 114 is located upstream of the desiccant reservoir 106 in/on the dryer air output line 110. In particular, the fan 114 can have a lower chance of failure in a lower humidity environment than in a higher humidity environment. The fan 114 may be used during the drying cycle to recirculate air within the dryer drum 102, and the fan 114 may be turned off during a desiccant regeneration cycle described below.

The desiccant reservoir 106 includes one or more desiccants along with a container that is configured to contain the one or more desiccants as well as to provide access to the one or more desiccants by the dryer ventilation line 104. The desiccant reservoir 106 can also include one or more dampers/valves used to selectively close off the desiccant reservoir 106 from the dryer ventilation line 104. In some embodiments, the desiccant reservoir 106 can be an integrated part of the dryer 100, such as when the desiccant reservoir 106 is positioned in a base of the dryer 100. In other embodiments, the desiccant reservoir 106 can be attachable to/detachable from the dryer 100. Additionally, the desiccant reservoir 106 can be configured to provide external access (such as by using a hatch) to the one or more desiccants contained. therein. As a desiccant is continually used and recharged, the desiccant can lose its effectiveness in absorbing or adsorbing water over time. Consequently, there may be a need to replace some or all of the desiccant in the desiccant reservoir 106 during the operational lifetime of the dryer 100.

A desiccant is a hygroscopic substance that can be used to absorb or adsorb water vapor in the air. As air is circulated through the dryer drum 102, which includes water-laden laundry, the relative humidity (such as the amount of water vapor present) of the air increases. This high-humidity air is introduced into the desiccant reservoir 106 via the dryer ventilation line 104, namely the dryer air output line 110. The desiccant in the desiccant reservoir 106 removes (either via absorption or adsorption) water vapor from the air. In so doing, the desiccant releases heat energy, which increases the temperature of the air that is returned back to the dryer drum 102 via the dryer ventilation line 104, namely the dryer air input line 112. By removing water vapor from the air, the returned air also has a reduced. relative humidity, and the returned air can be used to absorb or adsorb additional water vapor in the diver drum 102.

The dryer 100 is not limited to any particular type of desiccant(s) used in the desiccant reservoir 106. Examples of desiccants that may be used include zeolites (microporous aluminosilicate mineral), montmorilionite (MMT) clay, silica gel, aluminophosphate molecular sieves (synthetic zeolite), calcium oxide, calcium sulfate, and activated carbon. Other examples of desiccants that may be used include metal-organic frameworks (MOF) absorbents (such as MOF-801). While many desiccants are solid, the desiccant reservoir 106 can be adapted to use one or more liquid desiccants. For example, the desiccant reservoir 106 may include a solution pump that is configured to circulate the liquid desiccant through the desiccant reservoir 106.

The amount of desiccant needed will be based upon the absorption or adsorption properties of particular desiccant(s) selected to be used in the desiccant reservoir 106 and the intended maximum drying capacity (such as the amount of water capable of being removed from the laundry) of the dryer 100. Other factors that impact the type and/or amount of desiccant needed include the desired dryness (such as is measured as percent relative humidity) of the air leaving the dryer drum 102. For example, certain desiccants are more effective at a low relative humidity (such as 0-20%) than others. Additionally, certain desiccants have a greater carrying capacity (typically measured as a percentage of weight of water absorbed or adsorbed relative to the weight of the desiccant) and thus are more efficient in removing water vapor from the air. Still further, desiccants have varying equilibrium capacity, which is the relative humidity at which a desiccant can no longer absorb or adsorb water vapor from air at a given temperature. Typically, as temperature increases, the relative humidity (measured as a percentage) of the equilibrium capacity decreases.

There are many factors that could be used to select the desiccant(s) in the desiccant reservoir 106. Examples of these factors include water-load capacity as characterized by water absorption/adsorption isotherms. A water absorption/adsorption isotherm is the amount of water that a desiccant can hold as a function of its pressure at constant temperature. In some embodiments, a large difference of absorption/adsorption isotherms between the desiccant loading temperature and regeneration temperature is desired. Another factor in selecting a desiccant is dust-free operation. If the desiccant generates dust during operation, the dust could contaminate the laundry. Yet another factor involves having a desiccant that has both reliable operation and a long period of service life.

At least one dryness sensor 116 may be configured to measure the dryness of the air within the dryer ventilation line 104. The dryer 100 is not limited to any particular type of dryness sensor used as long as the dryness sensor 116 is capable of measuring/determining the dryness of air. As used herein, “dryness” can be determined by temperature and/or humidity. Dryness of air can also be expressed in relative humidity and absolute humidity, and these can be measured by humidity and temperature sensors in one or more other embodiments.

The dryer 100 may also include one or more isolation mechanisms 118 that is/are configured to isolate the dryer ventilation line 104 from the desiccant reservoir 106. The isolation mechanism(s) 118 may be controlled using the controller 108. The dryer 100 is not limited to any particular type of isolation mechanism used. For example, the isolation mechanism(s) 118 used to isolate the dryer ventilation line 104 from the desiccant reservoir 106 may be implemented using one or more actuating dampers/valves positioned within the dryer ventilation line 104.

In addition to the drying cycle, the dryer 100 also supports a desiccant regeneration cycle, which is used to remove moisture from the desiccant in the desiccant reservoir 106 so that the dryer 100 can be used during a subsequent drying cycle. The desiccant regeneration cycle does not necessarily immediately follow a drying cycle. Desiccants are limited in the amount of water vapor that can be absorbed or adsorbed from air. Consequently, the desiccant needs to be recharged to allow the desiccant to get closer to its original capacity for absorbingladsorbing water vapor from the air. The process for recharging the desiccant within the desiccant reservoir 106 includes circulating heated air from a heat pump 120 over or through the desiccant reservoir 106. A heat pump input line 122 connects the desiccant reservoir 106 to the heat pump 120 and conveys air out from the desiccant reservoir 106. A heat pump output line 124 connects the heat pump 120 to the desiccant reservoir 106 and conveys heated air out from the heat pump 120.

To remove water from the desiccant in the desiccant reservoir 106, the air being circulated over or through the desiccant typically needs to be within a particular temperature/relative humidity profile, which varies depending upon the type of desiccant being used. In general, the higher the temperature of the air, the greater the capacity of the air to remove water from the desiccant. Additionally, the lower the relative humidity of the air, the greater the capacity of the air to remove water from the desiccant. To increase the ability of air to remove water from the desiccant, the heat pump 120 can be used to increase the temperature of the air prior to reaching the desiccant reservoir 106.

As shown in FIG. 1, the heat pump 120 generally includes a compressor 126, a condenser 128, an evaporator 130, and an expansion valve 132. The compressor 126 generally operates to move a refrigerant through the heat pump 120. For example, the compressor 126 can receive the refrigerant at a lower temperature and a lower pressure from the evaporator 130 and compress the refrigerant, which allows the refrigerant at a higher temperature and a higher pressure to be provided to the condenser 128 as vapor. The condenser 128 condenses the vapor into a higher-temperature liquid, which releases heat into the air passing out of the heat pump 120. The heated air is provided to the desiccant reservoir 106 for use during desiccant regeneration. The higher-temperature liquid from the condenser 128 passes through the expansion valve 132, which allows the liquid to begin evaporating and provides a mixture of liquid and vapor to the evaporator 130. The evaporator 130 allows the liquid and vapor to expand and evaporate into vapor, which absorbs both latent and sensible heat from the air passing into the heat pump 120. This allows the heat pump 120 to be used to heat the air flowing out of the desiccant reservoir 106 and to provide the heated air back to the desiccant reservoir 106 for regeneration of the desiccant.

One or more fans 134, such as one or more mechanical fans, may be used to facilitate the flow of heated air from the heat pump 120 to the desiccant reservoir 106. Again, the dryer 100 is not limited to any particular type of fan 134. For example, the one or more fans 134 may be implemented as one or more axial flow fans or centrifugal fans. In some cases, the one or more fans 134 may be implemented as one or more fan/motor assemblies. In other cases, the one or more fans 134 may be driven by the same motor that drives the dryer drum 102. In addition, the dryer 100 is not limited to any particular location(s) of the fan(s) 134 within the heat pump input and output lines 122, 124. For instance, a fan 134 can be located upstream and/or downstream of the heat pump 120. The fan 134 may be used during the regeneration cycle when the desiccant is being regenerated, and the fan 134 may be turned off during a drying cycle. Also, the dryer 100 may include one or more isolation mechanisms 136 that is/are configured to isolate the heat pump 120 from the desiccant reservoir 106. The isolation mechanism(s) 136 may he controlled using the controller 108. The dryer 100 is not limited to any particular type of isolation mechanism used. For example, the isolation mechanism(s) 136 used to isolate the heat pump 120 from the desiccant reservoir 106 may be implemented using one or more actuating dampers/valves positioned within at least one of the heat pump input and output lines 122, 124.

In some cases, the dryer 100 may include an air filter 138 that can be used to prevent fabrics and lint from being provided to the desiccant reservoir 106. The dryer 100 is not limited to any particular type of air filter 138, examples of which may include a screen filter, a woven filter, or a nonwoven filter. Also, the condition of the desiccant within the desiccant reservoir 106 may be measured or determined using a recharge sensor 140. For example, the recharge sensor 140 can measure the moisture content of the desiccant within the desiccant reservoir 106, such as by using moisture trips similar to those widely-used in clothes dryers. Another approach for the recharge sensor 140 may involve monitoring the color of a color-changing desiccant. In addition, a condensate drainage 142 can be provided in the heat pump 120. As the warmer and moist air from the desiccant reservoir 106 passes through the evaporator 130, the moisture is condensed on the surface of the evaporator 130. The condensate drips downward towards the bottom of the evaporator 130, and the condensate drainage 142 allows the condensate to escape the heat pump 120. The condensate may be handled in any suitable manner, such as when the condensate is allowed to drip into a drain or is transported via a tube or pipe to a drain.

The use of the heat pump 120 here to regenerate the desiccant in the desiccant reservoir 106 can provide various advantages. For example, if only an electric heater is employed for desiccant regeneration, the electric energy consumption E_{reg-heater} during the regeneration process using the electric heater can be calculated as follows.

$${E}_{reg - heater} = {Q}_{reg} = {M}_{w} \cdot \frac{{h}_{vap}}{η} - {E}_{fan - reg}$$

Here, M_{w} represents a moisture load (in kg), hᵥₐₚ represents the heat evaporation of water (in kJ/kg), η represents thermal efficiency (so 1−η represents heat loss), and E_{ƒan-reg} represents energy usage by the fan 134 during the regeneration process. By utilizing the heat pump 120 instead of an electric heater, the electric energy consumption during the regeneration process using the heat pump 120 can be calculated as follows.

$${E}_{reg - hp} = {Q}_{reg} / {COP}_{h} = ( {M}_{w} \cdot \frac{{h}_{vap}}{η} - {E}_{fan - reg} ) / {COP}_{h}$$

Here, COPₕ represents the coefficient of performance (COP) of the heat pump 120. Assuming an average COPₕ of 2.5 and utilizing a standard Department of Energy test condition, the combined energy factor for the dryer 100 may be about 7.8, compared to about 3.8 for a traditional clothes dryer. In some embodiments, the heat pump 120 has a coefficient of performance of at least two.

While the combined energy factor for the dryer 100 here may be similar to that of a conventional heat pump dryer without desiccants, the drying cycle and the desiccant regeneration cycle of the dryer 100 do not need to occur around the same time. The desiccant in the desiccant reservoir 106 acts as a thermal storage, retaining captured moisture. The regeneration of the desiccant in the desiccant reservoir 106 can occur at any time between the completion of the current drying cycle and the beginning of the next drying cycle, which may occur one hour or more later (and possibly 24 hours or more later).

This extended period allows the heat pump 120 to regenerate the desiccant over a much longer timeframe, which can allow for a significant reduction in the overall size/weight of the dryer 100 and certain individual components of the dryer 100. This is because conventional heat pump dryers without desiccants generally need larger heat pumps in order to generate adequate heat for drying laundry items within a relatively short amount of time (often within 60 to 80 minutes). In contrast, the heat pump 120 here may only need to generate adequate heat for regenerating the desiccant in the desiccant reservoir 106 over a longer period of time, which allows the heat pump 120 to have a smaller size and a smaller capacity. As a particular example, assume that a heat pump for a dryer without desiccants may need to include a 1 kW to 2 kW compressor in order to dry laundry items within a specified amount of time, If the dryer 100 has the same overall design as the heat pump dryer but includes the desiccant reservoir 106, to dry the same laundry items within the same amount of time, the heat pump 120 here may include a 250 W to 500 W compressor 126. As another particular example, assume that a heat pump for a dryer without desiccants may need to include a compressor having a specified size in order to dry laundry items within a specified amount of time, If the dryer 100 has the same overall design as the heat pump dryer but includes the desiccant reservoir 106, to dry the same laundry items within the same amount of time, the heat pump 120 here may include a compressor 126 having a size that is about 25% of that specified size. In some cases, the size of the heat pump 120 may be reduced by up to a factor of ten compared the compressor of the heat pump dryer without desiccants.

A smaller heat pump size also results in less refrigerant usage within the heat pump 120. This may be particularly important since some refrigerants used in the heat pump 120 (like R290 refrigerant) can be highly flammable, so reducing the amount of refrigerant used within the heat pump 120 can result in a safer design. As a particular example, while some conventional heat pump dryers may use upwards of 150 grams of refrigerant or more, the dryer 100 may use substantially less, such as 20 to 30 grams of refrigerant. In addition, the ability to use a smaller compressor 126 may allow the dryer 100 to be powered using a 120 V electrical outlet, rather than a 240 V electrical outlet required by many conventional electric dryers. This enables easier installation of the dryer 100, such as in circumstances where a natural-gas dryer (which typically uses a 120 V connection) is being replaced. If the natural-gas dryer is being replaced by a conventional electric dryer, this could ordinarily require rewiring to add a 240 V electrical outlet, but this may not be needed when the dryer 100 can be used with an existing 120 V connection.

As an example of this, assume that Qₕ is the total heat needed to regenerate the desiccant after drying a load of laundry. Qₕ is approximately equal to Q_{reg}. In a conventional heat pump dryer, the required capacity of the heat pump \dot{Q}_{conv} in watts can be expressed as follows.

$${\dot{Q}}_{conv} = \frac{{Q}_{h}}{Δ {τ}_{conv}}$$

Here, Δτ_{conv} is the drying time of the conventional heat pump dryer, which may typically be around one hour (3,600 seconds). In the dryer 100, the required capacity of the heat pump 120 may be expressed as follows.

$${\dot{Q}}_{des} = \frac{{Q}_{h}}{Δ {τ}_{des}}$$

Here, Δτ_{des} is the desiccant regeneration time of the desiccant in the desiccant reservoir 106, which may be several hours or even days. If the desiccant regeneration time is four hours (14,400 seconds), the capacity ratio would be:

$$\frac{{\dot{Q}}_{des}}{{\dot{Q}}_{conv}} = \frac{Δ {τ}_{conv}}{Δ {τ}_{des}} = \frac{3600}{14400} = 0.25$$

Thus, the capacity of the heat pump 120 in the dryer 100 may be only 25% of that in a conventional heat system.

In addition, the dryer 100 provides the inherent ability to utilize time of use effectively, since the regeneration of the desiccant can be carried out at any suitable times (such as at night or during other off-peak hours). In other words, it is possible for the dryer 100 to perform a drying cycle during a first time period and perform a desiccant regeneration cycle during a second time period that is displaced (possibly significantly) in time from the first time period.

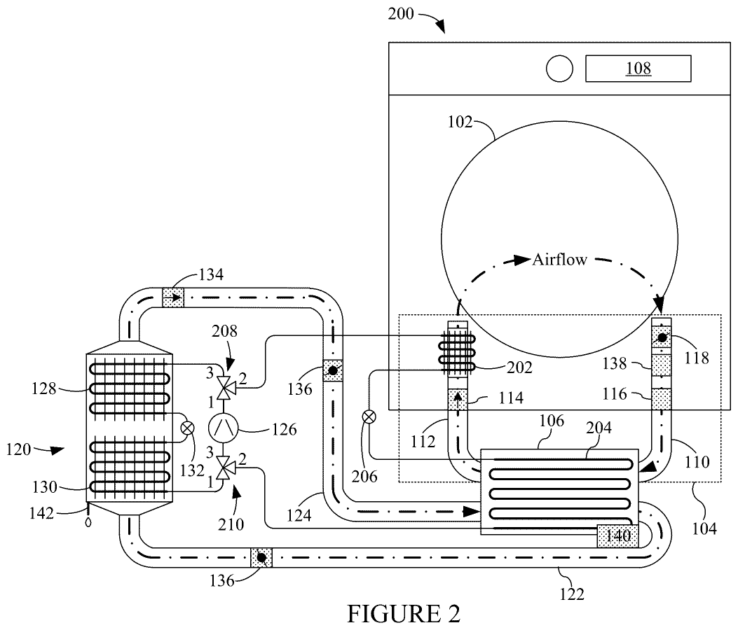

FIG. 2 illustrates another example desiccant-based laundry dryer 200 supporting heat pump-based desiccant regeneration in accordance with this disclosure. The dryer 200 in FIG. 2 includes various components that are common with the dryer 100 in FIG. 1. In this example, however, the heat pump 120 is implemented as a dual-loop heat pump system. A first loop of the heat pump 120 includes the condenser 128, evaporator 130, and expansion valve 132. A second loop of the heat pump 120 includes a secondary condenser 202, a secondary evaporator 204, and a secondary expansion valve 206. The second loop of the heat pump 120 may operate in the same or similar manner as the first loop of the heat pump 120 described above. Here, however, the secondary condenser 202 is configured to increase an inlet temperature to the dryer drum 102 during a drying cycle, meaning the secondary condenser 202 increases the temperature of the air entering the dryer drum 102 via the dryer air input line 112. Also, the secondary evaporator 204 is configured to decrease a temperature of the desiccant reservoir 106 during the drying cycle, which can lead to better absorption/adsorption by the desiccant in the desiccant reservoir 106. Both of these can thereby help to shorten the time needed by the dryer 200 o complete the drying cycle. Although not shown here, an isolation mechanism 118 may be used along the dryer air input line 112 as in FIG. 1.

A first three-way valve 208 can be used to selectively couple two of the compressor 126, the condenser 128, and the secondary condenser 202. A second three-way valve 210 can be used to selectively couple two of the compressor 126, the evaporator 130, and the secondary evaporator 204. For example, each three-way valve 208 and 210 here includes three ports labeled “1,” “2,” and “3.” Each three-way valve 208 and 210 can be used to couple two of its ports together, such as when two of the ports are coupled so that fluid (liquid or gas) can flow between those two ports, while the third port is blocked.

During a drying cycle, ports 2 and 3 of the three-way valve 208 and ports 1 and 2 of the three-way valve 210 can be opened, while port 1 of the three-way valve 208 and port 3 of the three-way valve 210 can be closed. Also, the fan 114 can be turned on, and the fan 134 can be turned off. This couples the condensers 128 and 202 together and couples the evaporators 130 and 204 together, which allows for heating of the air entering the dryer drum 102 and for cooling of the desiccant reservoir 106. During a desiccant regeneration cycle, ports 1 and 3 of the three-way valve 208 and ports 1 and 3 of the three-way valve 210 can be opened, while port 2 of the three-way valve 208 and port 2 of the three-way valve 210 can be closed. Also, the fan 114 can be turned off, and the fan 134 can be turned on. This couples each of the condenser 128 and the evaporator 130 to the compressor 126, which allows for heating of the air entering the desiccant reservoir 106.

Note that the dryer 200 can achieve some or all of the same benefits as the dryer 100 described above, such as a reduction in the capacity and size of the heat pump 120, a reduction in refrigerant usage, an ability to be powered using a 120 V electrical outlet, and an ability to utilize time of use effectively. Moreover, the secondary heat pump loop can be used by the dryer 200 to increase the inlet temperature of the dryer drum 102 and decrease the temperature of the desiccant reservoir 106 during drying cycles, each of which can help to decrease drying times.

Although FIGS. 1 and 2 illustrate examples of desiccant-based laundry dryers 100 and 200 supporting heat pump-based desiccant regeneration, various changes may be made to FIGS. 1 and 2. For example, the size, shape, and dimensions of each dryer 100 and 200 and its individual components can vary as needed or desired. Also, various components shown each of FIGS. 1 and 2 can reside within the associated dryer 100 and 200 (such as in a base of the dryer) or external to the associated dryer 100 and 200. In addition, various implementations may support the use of an “all in one” or combination system in which a washing machine and a dryer are incorporated into the same package. In those cases, each of the dryers 100 and 200 may actually represent a combination of a washing machine and a dryer and include various components to facilitate washing and drying of laundry items in the same drum 102. It will be understood that the term “dryer drum” refers to a drum in which at least drying of laundry items (and optionally washing of laundry items) may occur.

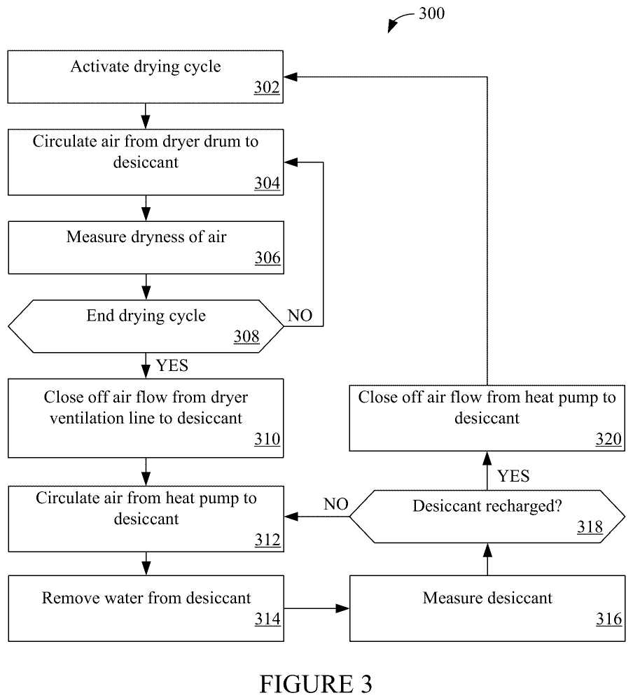

FIG. 3 illustrates an example method 300 for using a desiccant-based laundry dryer supporting heat pump-based desiccant regeneration in accordance with this disclosure. For ease of explanation, the method 300 is described as being performed using the dryer 100 of FIG. 1 or the dryer 200 of FIG. 2. However, the method 300 may be performed using any other suitable desiccant-based laundry dryer supporting heat pump-based desiccant regeneration designed in accordance with this disclosure. At least some of the operations described in connection with FIG. 3 may be performed and/or initiated under the control of the controller 108.

As shown in FIG. 3, beginning in block 302, a drying cycle begins with the dryer 100 or 200 being activated (such as turned on) after a load of laundry (such as wet clothes, towels, etc.) is loaded into the dryer drum 102 of the dryer 100 or 200. In block 304, air from the dryer drum 102 is circulated, via the dryer ventilation line 104, through a desiccant reservoir 106 and eventually back to the dryer drum 102. In some embodiments, the three-way valves 208 and 210 may be configured to couple the condensers 128 and 202 and to couple the evaporators 130 and 204. This can help to increase the inlet temperature to the dryer drum 102 and decrease the temperature of the desiccant reservoir 106 during the drying cycle. In block 306, the dryness of the air within the dryer ventilation line 104 can be measured using the dryness sensor 116.

In block 308, a determination is made whether to end the drying cycle. Note that the dryer 100 or 200 is not limited to any particular approach in making this determination. In one or more example implementations, the drying cycle of the dryer 100 or 200 can end based upon a preset amount of time passing or based upon a measured humidity level of the air from the dryer drum 102. For example, using information provided by the dryness sensor 116, a determination can be made, such as by using the controller 108, to end the drying cycle after the relative humidity reaches a preset amount that is either selected manually (such as by the user) or determined automatically (such as based upon a user selection of the type of material being dried). If a determination is made not to end the drying cycle, the process returns to block 304.

In block 310, after the determination is made to end the drying cycle, the dryer ventilation line 104 can be isolated from the desiccant reservoir 106, such as by using the isolation mechanism(s) 118 (like dampers or valves). Note that the dryer 100 or 200 is not limited to any particular approach for implementing the isolation described. This closes off or stops the air flow through the dryer ventilation line 104 between the dryer drum 102 and the desiccant reservoir 106. In block 312, the controller 108 causes air from the heat pump 120 to circulate to the desiccant in the desiccant reservoir 106. In block 314, water is removed from the desiccant in the desiccant reservoir 106 by the circulating air from the heat pump 120. In block 316, the desiccant within the desiccant reservoir 106 is measured with the recharge sensor 140. For example, the recharge sensor 140 can measure the moisture content using moisture trips or by monitoring the color of a color-changing desiccant.

In block 318, a determination is made whether the desiccant has been recharged so that the regeneration cycle can end. Note that the dryer 100 or 200 is not limited to any particular approach in making this determination. The temperature and humidity of the air at the exit of the desiccant reservoir 106 and the moisture content of the desiccant change over time during the regeneration cycle, and the controller 108 can determine an end point of the regeneration cycle based on air temperature, humidity, and moisture content of the desiccant (such as by using an output of a moisture trip embedded in the desiccant). If a determination is made not to end the regeneration cycle, the process returns to block 312. In block 320, after the determination is made to end the regeneration cycle, the heat pump 120 can be isolated from the desiccant reservoir 106. Note that the dryer 100 or 200 is not limited to any particular approach for doing so. For example, the isolation of the heat pump 120 from the desiccant reservoir 106 can be accomplished using actuating dampers/valves (such as isolation mechanisms 136). This closes off or stops the air flow between the heat pump 120 and the desiccant reservoir 106.

Although FIG. 3 illustrates one example of a method 300 for using a desiccant-based laundry dryer supporting heat pump-based desiccant regeneration, various changes may be made to FIG. 3. For example, while shown as a series of steps, various steps in FIG. 3 may overlap, occur in parallel, occur in a different order, or occur any number of times. As a specific example, al though the desiccant regeneration cycle is illustrated as occurring after the drying cycle, the desiccant regeneration cycle does not necessarily immediately follow the drying cycle.

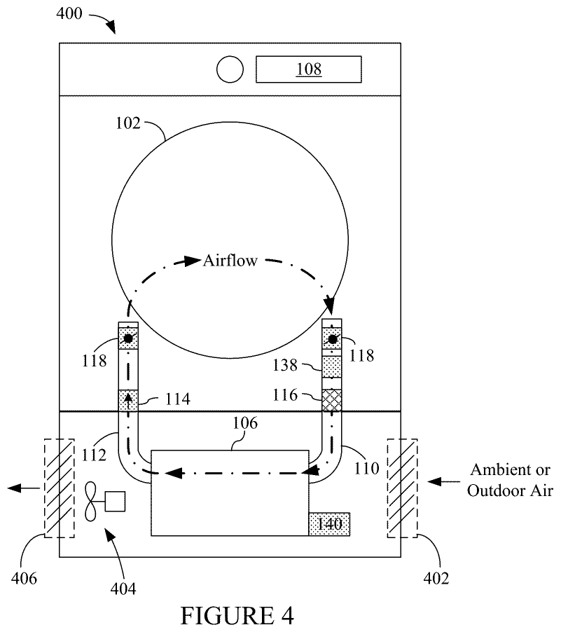

FIG. 4 illustrates an example desiccant-based laundry dryer 400 supporting air-based desiccant regeneration in accordance with this disclosure. The dryer 400 in FIG. 4 includes various components that are common with the dryers 100 and 200 in FIGS. 1 and 2. However, in this example, the desiccant in the desiccant reservoir 106 is regenerated solely using ambient or outdoor air that is pulled through an inlet port 402 (such as louvers) via one or more fans 404. The airflow may continue out through an outlet port 406 (such as louvers).

During a drying cycle, the fan 114 can be activated to circulate air through the dryer drum 102 and the desiccant reservoir 106, and the fan 404 can be turned off. After the drying cycle is complete, desiccant regeneration can occur. During desiccant regeneration, the fan 404 can be activated to pull in the ambient or outdoor air over or through the desiccant, and the fan 114 can be turned off. The air absorbs moisture from the desiccant and is subsequently discharged back indoors or outdoors.

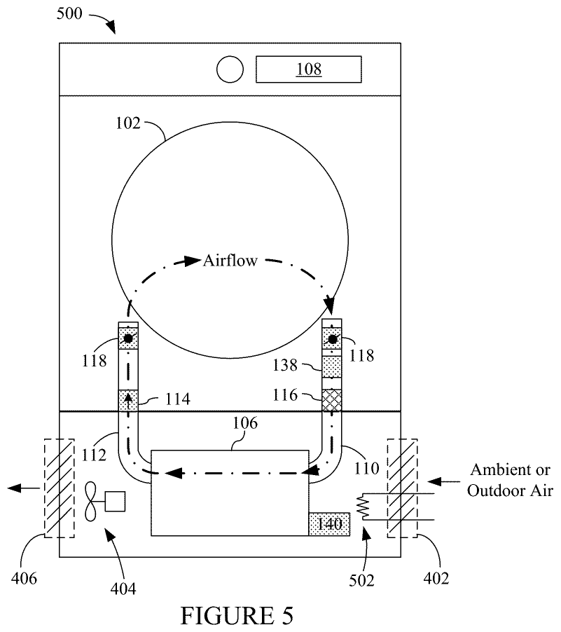

FIG. 5 illustrates another example desiccant-based laundry dryer 500 supporting air-based desiccant regeneration in accordance with this disclosure. The dryer 500 in FIG. 5 includes various components that are common with the dryer 400 in FIG. 4. In this example, however, a heater 502 is placed in the flow path of the ambient or outdoor air to add additional heat energy to support regeneration of the desiccant in the desiccant reservoir 106.

During a drying cycle, the fan 114 can be activated to circulate air through the dryer drum 102 and the desiccant reservoir 106, and the fan 404 can be turned off. After the drying cycle is complete, desiccant regeneration can occur and may occur in two phases. During a first phase of the desiccant regeneration, the fan 404 can be activated to pull in ambient or outdoor air over or through the desiccant, and the fan 114 can be turned off. The air absorbs moisture and is subsequently discharged back indoors or outdoors. In the first phase, the desiccant can be highly saturated with moisture, making it relatively easy to employ indoor or outdoor air to remove the moisture from the desiccant. However, as time progresses, the desiccant becomes less saturated. Thus, during a second phase of the desiccant regeneration, the heater 502 and the fan 114 can both be turned on in order to provide additional heat to the desiccant in order to facilitate removal of additional moisture from the desiccant.

Although FIGS. 4 and 5 illustrate examples of desiccant-based laundry dryers 400 and 500 supporting air-based desiccant regeneration, various changes may be made to FIGS. 4 and 5. For example, the size, shape, and dimensions of each dryer 400 and 500 and its individual components can vary as needed or desired. Also, various components shown each of FIGS. 4 and 5 can reside within the associated dryer 400 and 500 (such as in a base of the dryer) or external to the associated dryer 400 and 500. In addition, various implementations may support the use of an “all in one” or combination system in which a washing machine and a dryer are incorporated into the same package. In those cases, each of the dryers 400 and 500 may actually represent a combination of a washing machine and a dryer and include various components to facilitate washing and drying of laundry items in the same drum 102.

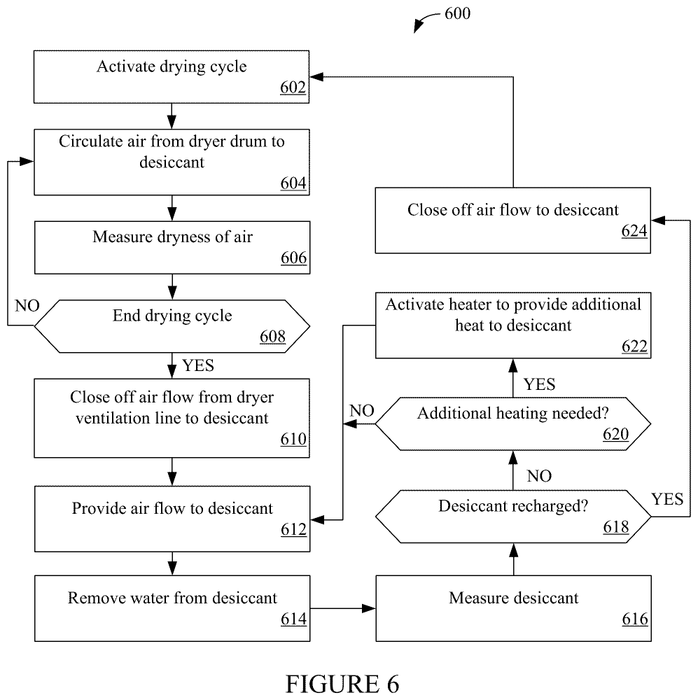

FIG. 6 illustrates an example method 600 for using a desiccant-based laundry dryer supporting air-based desiccant regeneration in accordance with this disclosure. For ease of explanation, the method 600 is described as being performed using the dryer 400 of FIG. 4 or the dryer 500 of FIG. 5. However, the method 600 may be performed using any other suitable desiccant-based laundry dryer supporting air-based desiccant regeneration designed in accordance with this disclosure. At least some of the operations described in connection with FIG. 6 may be performed and/or initiated under the control of the controller 108.

As shown in FIG. 6, blocks 602-610 may be the same as or similar to the corresponding blocks in FIG. 3 described above. During these blocks, the fan 404 may be turned off so as to not draw ambient or outdoor air over or through the desiccant in the desiccant reservoir 106. In block 612, the controller 108 causes ambient or outdoor air to be passed over or through the desiccant reservoir 106. In block 614, water is removed from the desiccant in the desiccant reservoir 106 by the air. As noted above, at least during the first portion of the regeneration cycle, the dryer 400 or 500 can recharge the desiccant within the desiccant reservoir 106 solely with ambient or outdoor air that is pulled through the inlet port 402 via the fan 404. The ambient or outdoor air has a lower humidity and can remove water from the desiccant, thereby at least partially recharging the desiccant within the desiccant reservoir 106. The water-laden air (from the desiccant) can be discharged, such as into the ambient environment or outdoors, via the outlet port 406.

In block 616, the desiccant within the desiccant reservoir 106 is measured with the recharge sensor 140. For example, the recharge sensor 140 can measure the moisture content using moisture trips or by monitoring the color of a color-changing desiccant. In block 618, a determination is made whether to end the regeneration cycle. Note that the dryer 400 or 500 is not limited to any particular approach in making this determination. The temperature and humidity of the air at the exit of the desiccant reservoir 106 and the moisture content of the desiccant change over time during the regeneration cycle, and the controller 108 can determine an end point of the regeneration cycle based on air temperature, humidity, and moisture content of the desiccant (such as by using an output of a moisture trip embedded in the desiccant).

If a determination is made not to end the regeneration cycle, in block 620, a determination is made whether additional heating may be needed to complete the regeneration cycle. Note that the dryer 400 or 500 is not limited to any particular approach in making this determination. For example, the controller 108 may determine whether the moisture content of the desiccant is not decreasing as quickly as desired. If additional heating is not needed, the process returns to block 612. Otherwise, in block 622, the heater 502 is activated to provide additional heat to the desiccant, and the process returns to block 612. Note that blocks 620 and 622 are optional since some embodiments may not support the use of additional heating (like the dryer 400). If a determination is made to end the regeneration cycle, in block 624, the ambient or outdoor air can be isolated from the desiccant reservoir 106. Note that the dryer 400 or 500 is not limited to any particular approach for doing so. For example, the isolation of the desiccant reservoir 106 from the ambient or outdoor air can be accomplished using actuating damperslvalves or by turning off the fan 404.

Although FIG. 6 illustrates one example of a method 600 for using a desiccant-based laundry dryer supporting air-based desiccant regeneration, various changes may be made to FIG. 6. For example, while shown as a series of steps, various steps in FIG. 6 may overlap, occur in parallel, occur in a different order, or occur any number of times. As a specific example, although the desiccant regeneration cycle is illustrated as occurring after the drying cycle, the desiccant regeneration cycle does not necessarily immediately follow the drying cycle.

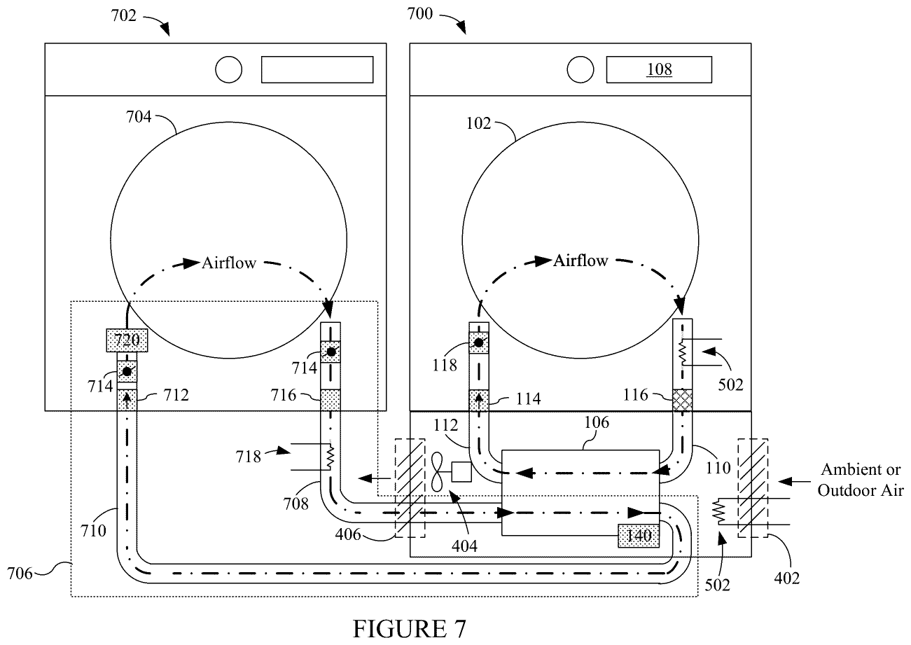

FIG. 7 illustrates an example desiccant-based laundry dryer 700 supporting external appliance-based desiccant regeneration in accordance with this disclosure. The dryer 700 in FIG. 7 includes various components that are common with the dryer 500 in FIG. 5. In this example, however, the desiccant in the desiccant reservoir 106 can also be regenerated. using assistance from an external appliance. In the example shown in FIG. 7, the external appliance represents a washing machine 702.

As shown in FIG. 7, the washing machine 702 includes a washer drum 704 and a washer ventilation line 706. Note that the desiccant reservoir 106 here may be included as part of the dryer 700, as part of the washing machine 702, or as a separate subsystem used by the dryer 700 and/or the washing machine 702. The washer ventilation line 706 includes a washer air output line 708 that connects the washer drum 704 to the desiccant reservoir 106 and conveys air out from the washer drum 704. The washer ventilation line 706 also includes a washer air input line 710 that connects the desiccant reservoir 106 to the washer drum 704 and conveys air into the washer drum 704.

One or more fans 712, such as one or more mechanical fans, may be used to facilitate air flow through the washer drum 704. The washing machine 702 is not limited to any particular type of fan 712. For example, the one or more fans 712 may be implemented as one or more axial flow fans or centrifugal fans. In some cases, the one or more fans 712 may be implemented as one or more fan/motor assemblies. In other cases, the one or more fans 712 may be driven by the same motor that drives the washer drum 704. In addition, the washing machine 702 is not limited to any particular location(s) of the fan(s) 712 within the washer ventilation line 706. For instance, a fan 712 can be located upstream and/or downstream of the washer drum 704. The fan 712 may be used during a regeneration cycle to circulate air from the washing machine 702 to the desiccant reservoir 106.

The washing machine 702 may include one or more isolation mechanisms 714 that is/are configured to isolate the washer ventilation line 706 from the desiccant reservoir 106. The isolation mechanism(s) 714 may be controlled using the controller 108. The washing machine 702 is not limited to any particular type of isolation mechanism used. For example, the isolation mechanism(s) 714 used to isolate the washer ventilation line 706 from the desiccant reservoir 106 may be implemented using one or more actuating dampers/valves positioned within the washer ventilation line 706. In some cases, the washing machine 702 may include an air filter 716 that can be used to prevent fabrics and lint from being provided to the desiccant reservoir 106. The washing machine 702 is not limited to any particular type of air filter 716, examples of which may include a screen filter, a woven filter, or a nonwoven filter. To increase the ability of air within the washer ventilation line 706 to remove water from the desiccant in the desiccant reservoir 106, a heater 718 can optionally be provided to increase the temperature of the air prior to reaching the desiccant reservoir 106. The heater 718 may be positioned on either the suction side or the discharge side of the fan 72. In this example, the heater 718 is positioned within the washer air output line 708.

During a drying cycle, the fan 114 can be activated to circulate air through the dryer drum 102 and the desiccant reservoir 106, and the fans 404 and 712 can be turned off. After the drying cycle is complete, desiccant regeneration can occur and may occur in two phases. During a first phase of the desiccant regeneration, the fan 404 can be activated to pull in ambient or outdoor air over or through the desiccant, and the fans 114 and 712 can be turned off. The air absorbs moisture and is subsequently discharged back indoors or outdoors. In the first phase, the desiccant can be highly saturated with moisture, making it relatively easy to employ indoor or outdoor air to remove the moisture from the desiccant. However, as time progresses, the desiccant becomes less saturated. Thus, during a second phase of the desiccant regeneration, waste heat from the dryer 700 can be provided to the washing machine 702 for use. During the second phase, the fan 404 may remain activated, and the fan 712 can be turned, on. This draws warmer air over or through the desiccant in the desiccant reservoir 106, and the air exits the desiccant reservoir 106 and passes through the washer air input line 710 to a heat and mass exchange device 720. The heat and mass exchange device 720 can transfer sensible and latent heat to tub water contained in the washer drum 704 of the washing machine 702. If at some point additional heat is needed, the heater 718 may be activated to produce additional heat for the desiccant reservoir 106. In some cases, this type of approach offers high energy efficiency and may reduce the amount of desiccant used in the desiccant reservoir 106.

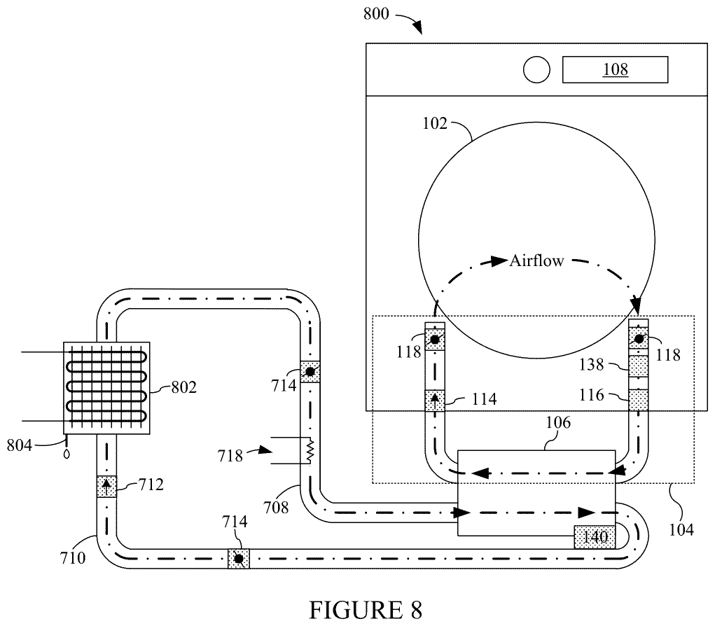

FIG. 8 illustrates another example desiccant-based laundry dryer 800 supporting external appliance-based desiccant regeneration in accordance with this disclosure. The dryer 800 in FIG. 8 includes various components that are common with the dryer 700 in FIG. 7. In this example, however, the external appliance in the form of the washing machine 702 has been replaced by a heat exchanger 802. The heat exchanger 802 can represent a direct contact or indirect heat exchanger, where warmer air from the desiccant reservoir 106 is received during a regeneration cycle. Sensible and latent heat in the warmer air is transferred to water or other material by the heat exchanger 802. The heater 718 (if present) can be activated during the regeneration cycle to heat the air being recirculated back to the desiccant reservoir 106. The water or other material heated by the heat exchanger 802 may be used for any suitable purposes. For example, the heat exchanger 802 may form a part of or be used in conjunction with a hot water tank, a dishwasher, or a washing machine. A condensate drainage 804 can be provided in the heat exchanger 802 to allow condensate to drain from the heat exchanger 802 (similar to the condensate drainage 142).

Although FIGS. 7 and 8 illustrate examples of desiccant-based laundry dryers 700 and 800 supporting external appliance-based desiccant regeneration, various changes may be made to FIGS. 7 and 8. For example, the size, shape, and dimensions of each dryer 700 and 800 and its individual components can vary as needed or desired. Also, various components shown each of FIGS. 7 and 8 can reside within the associated dryer 700 and 800 (such as in a base of the dryer) or external to the associated dryer 700 and 800. In addition, while the external appliances are described here as representing a washing machine 702 and a heat exchanger 802, any other suitable external appliances may be used in conjunction with each dryer 700 or 800.

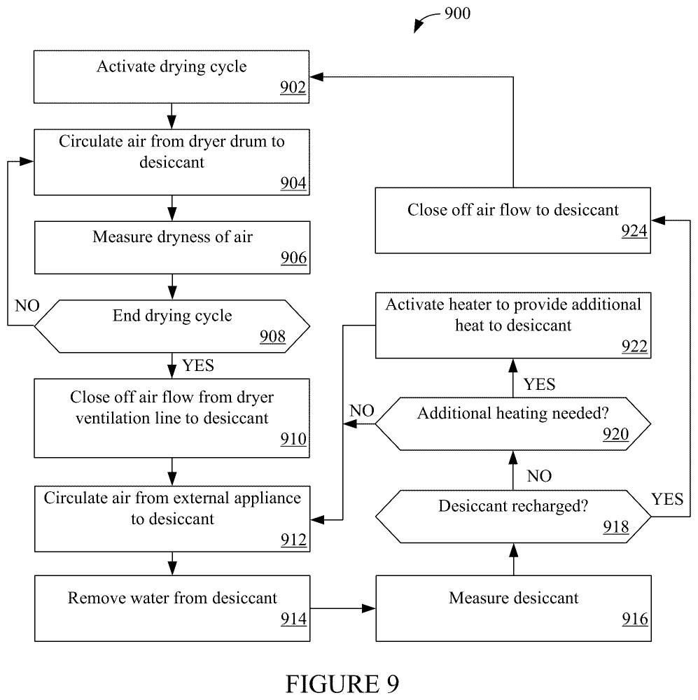

FIG. 9 illustrates an example method 900 for using a desiccant-based laundry dryer supporting external appliance-based desiccant regeneration in accordance with this disclosure. For ease of explanation, the method 900 is described as being performed using the dryer 700 of FIG. 7 or the dryer 800 of FIG. 8. However, the method 900 may be performed using any other suitable desiccant-based laundry dryer supporting external appliance-based desiccant regeneration designed in accordance with this disclosure. At least some of the operations described in connection with FIG. 9 may be performed and/or initiated under the control of the controller 108.

As shown in FIG. 9, blocks 902-910 may be the same as or similar to the corresponding blocks in FIG. 3 described above. During these blocks, the fan 404 (if present) may be turned off so as to not draw ambient or outdoor air over or through the desiccant in the desiccant reservoir 106, and the fan 712 may be turned off so as to not draw air from an external appliance over or through the desiccant in the desiccant reservoir 106. In block 912, the controller 108 causes air from an external appliance to be passed over or through the desiccant reservoir 106. This may or may not occur in conjunction with air passing over or through the desiccant reservoir 106 based on operation of the fan 404. In block 914, water is removed from the desiccant in the desiccant reservoir 106 by the air. As noted above, at least during the first portion of the regeneration cycle, the dryer 700 or 800 can recharge the desiccant within the desiccant reservoir 106 based on the flow of air from the external appliance.

In block 916, the desiccant within desiccant reservoir 106 is measured with the recharge sensor 140. For example, the recharge sensor 140 can measure the moisture content using moisture trips or monitoring the color of a color-changing desiccant. In block 918, a determination is made whether to end the regeneration cycle. Note that the dryer 700 or 800 is not limited to any particular approach in making this determination. The temperature and humidity of the air at the exit of the desiccant reservoir 106 and the moisture content of the desiccant change over time during the regeneration cycle, and the controller 108 can determine an end point of the regeneration cycle based on air temperature, humidity, and moisture content of the desiccant (such as by using an output of a moisture trip embedded in the desiccant).

If a determination is made not to end the regeneration cycle, in block 920, a determination is made whether additional heating may be needed to complete the regeneration cycle. Note that the dryer 700 or 800 is not limited to any particular approach in making this determination. For example, the controller 108 may determine whether the moisture content of the desiccant is not decreasing as quickly as desired. If additional heating is not needed, the process returns to block 912. Otherwise, in block 922, the heater 718 is activated to provide additional heat to the desiccant, and the process returns to block 912. Note that blocks 920 and 922 are optional since some embodiments may not support the use of additional heating. If a determination is made to end the regeneration cycle, in block 924, the air from the external appliance can be isolated from the desiccant reservoir 106. Note that the dryer 700 or 800 is not limited to any particular approach for doing so. For example, the isolation of the desiccant reservoir 106 from the external appliance can be accomplished using actuating dampers/valves.

Although FIG. 9 illustrates one example of a method 900 for using a desiccant-based laundry dryer supporting external appliance-based desiccant regeneration, various changes may be made to FIG. 9. For example, while shown as a series of steps, various steps in FIG. 9 may overlap, occur in parallel, occur in a different order, or occur any number of times. As a specific example, although the desiccant regeneration cycle is illustrated as occurring after the drying cycle, the desiccant regeneration cycle does not necessarily immediately follow the drying cycle.

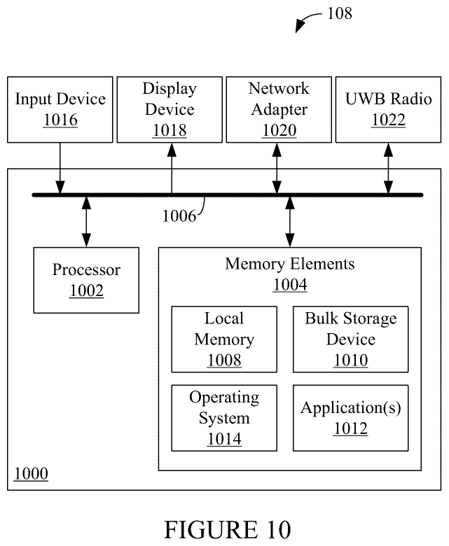

FIG. 10 illustrates an example controller 108 for use with a desiccant-based. laundry dryer in accordance with this disclosure. The controller 108 may, for example, be used with any of the desiccant-based laundry dryers described above. As shown in FIG. 10, in this example, the controller 108 is implemented using a data processing system 1000. The data processing system 1000 can include at least one processor 1002 (such as a central processing unit) coupled to memory elements 1004 through a system bus 1006 or other suitable circuitry. As such, the data processing system 1000 can store program code within the memory elements 1004. The processor 1002 can execute the program code accessed from the memory elements 1004 via the system bus 1006. It should be appreciated that the data processing system 1000 can be implemented in the form of any system including a processor and memory that are capable of performing the functions and/or operations described within this specification. For example, the data processing system 1000 can be implemented as a computer system, an embedded computer system, a system-on-chip, or the like.

The memory elements 1004 can include one or more physical memory devices such as, for example, local memory 1008 and one or more bulk storage devices 1010. Local memory 1008 refers to random access memory (RAM) or other non-persistent memory device(s) generally used during actual execution of the program code (such as one or more applications 1012 and/or an operating system 1014). it should be appreciated that the application(s) 1012 and/or operating system 1014, upon execution, causes the processor 1002 to perform and/or initiate the operations described herein. In some cases, the operating system 1014 and application(s) 1012 may be combined as a single program that, upon execution, causes the processor 1002 to perform and/or initiate the operations described herein. The bulk storage device(s) 1010 can be implemented as a hard disk drive (HDD), solid state drive (SSD), or other persistent data storage device. The data processing system 1000 can also include one or more cache memories that provide temporary storage of at least some program code in order to reduce the number of times that the program code needs to be retrieved from the local memory 1008 and/or the bulk storage device 1010 during execution.

Input/output (I/O) devices such as an input device 1016 and a display device 1018 (either separately or integrated together as a touchscreen, for example) can be coupled to or included in the data processing system 1000. In one or more examples, the input device 1016 may include one or more buttons, dials, and/or other tactile controls. The display device 1018 may be a touchscreen. It should be appreciated that the I/O devices may be implemented as an integrated touchscreen without any tactile controls, include one or more tactile controls in combination with the touchscreen, or include a display (such as non-touchscreen) in combination with one or more tactile controls. The I/O devices can be coupled to the data processing system 1000 either directly or through intervening I/O controllers. For example, the display device 1018 can be coupled to the data processing system 1000 via a graphics processing unit (GPU), which may be a component of the processor 1002 or a discrete device.

One or more network adapters 1020 can also be coupled to the data processing system 1000 to enable the data processing system 1000 to become coupled to other systems, computer systems, remote printers, and/or remote storage devices through intervening private or public networks. Modems, cable modems, transceivers, and Ethernet cards are examples of different types of network adapters 1020 that can be used with data processing system 1000. The data processing system 1000 can also include an Ultra-Wideband (UWB) radio 1022, which is configured to both send and receive wireless, very low energy level signals suitable for short-range, high-bandwidth communications over a large portion of the radio spectrum.

Although FIG. 10 illustrates one example of a controller 108 for use with a desiccant-based laundry dryer, various changes may be made to FIG. 10. For example, computing and communication devices and systems come in a wide variety of configurations, and FIG. 10 does not limit this disclosure to any particular computing or communication device or system.

It should be noted that while FIGS. 1, 2, 4, 5, 7, and 8 described above illustrate examples of various desiccant-based laundry dryers, embodiments of desiccant-based laundry dryers may include any suitable combinations of features shown in or described with respect to FIGS. 1, 2, 4, 5, 7, and 8. For example, any combination of features shown in these figures could be used in a single desiccant-based laundry dryer, whether or not that specific combination of features is shown in the figures or described above. Thus, for example, ambient or outdoor air may be used with any of the desiccant-based laundry dryers described above, including in the dryers 100, 200, and 800 described above.

The terminology used herein is for the purpose of describing particular embodiments only and is not intended to be limiting. Notwithstanding, several definitions that apply throughout this document are expressly defined as follows.

As defined herein, the singular forms “a,” “an,” and “the” are intended to include the plural forms as well, unless the context clearly indicates otherwise.

As defined herein, the terms “at least one,” “one or more,” and “and/or,” are open-ended expressions that are both conjunctive and disjunctive in operation unless explicitly stated otherwise. For example, each of the expressions “at least one of A, B, and C,” “at least one of A, B, or C,” “one or more of A, B, and C,” “one or more of A, B, or C,” and “A, B, and/or C” means A alone; B alone; C alone; A and B together; A and C together; B and C together; or A, B and C together.

As defined herein, the term “automatically” means without human intervention.

As defined herein, the term “computer readable storage medium” means a storage medium that contains or stores program code for use by or in connection with an instruction execution system, apparatus, or device. As defined herein, a “computer readable storage medium” is not a transitory, propagating signal per se. A computer readable storage medium may be, but is not limited to, an electronic storage device, a magnetic storage device, an optical storage device, an electromagnetic storage device, a semiconductor storage device, or any suitable combination of the foregoing. The different types of memory, as described, herein, are examples of a computer readable storage media. A non-exhaustive list of more specific examples of a computer readable storage medium may include: a portable computer diskette, a hard disk, a random-access memory (RAM), a read-only memory (ROM), an erasable programmable read-only memory (EPROM or Flash memory), a static random-access memory (SRAM), a portable compact disc read-only memory (CD-ROM), a digital versatile disk (DVD), a memory stick, a floppy disk, or the like.

As defined herein, “data processing system” means one or more hardware systems configured to process data, each hardware system including at least one processor programmed to initiate operations and memory.

As defined herein, “execute” and “run” comprise a series of actions or events performed by the processor in accordance with one or more machine-readable instructions. “Running” and “executing,” as defined herein refer to the active performing of actions or events by the processor. The terms run, running, execute, and executing are used synonymously herein,

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “individual” and “user” each refer to a human being.

As defined herein, the term “processor” means at least one hardware circuit (such as a hardware processor). The hardware circuit may be configured to carry out instructions contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “responsive to” and similar language as described above (such as “if,” “when,” or “upon,”) mean responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

As defined herein, “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms “first,” “second,” etc. may be used herein to describe various elements. These elements should not be limited by these terms, as these terms are only used to distinguish one element from another unless stated otherwise or the context clearly indicates otherwise.

A computer program product may include a computer readable storage medium (or media) having computer readable program instructions thereon for causing a processor to carry out aspects of the present disclosure. Within this disclosure, the term “program code” is used interchangeably with the term “computer readable program instructions.” Computer readable program instructions described herein may be downloaded to respective computing/processing devices from a computer readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations for the inventive arrangements described herein may be assembler instructions, instruction-set-architecture (ISA) instructions, machine instructions, machine dependent instructions, microcode, firmware instructions, or either source code or object code written in any combination of one or more programming languages, including an object-oriented. programming language and/or procedural programming languages. Computer readable program instructions may specify state-setting data. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the computer readable program instructions by utilizing state information of the computer readable program instructions to personalize the electronic circuitry, in order to perform aspects of the inventive arrangements described herein.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by computer readable program instructions, such as program code.

These computer readable program instructions may be provided to a processor of a computer, special purpose computer, or other programmable data processing apparatus to produce a machine, such that the instructions, which execute via the processor of the computer or other programmable data processing apparatus, create means for implementing the functionsla.cts specified in the flowchart and/or block diagram block or blocks. In this way, operatively coupling the processor to program code instructions transforms the machine of the processor into a special-purpose machine for carrying out the instructions of the program code. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the operations specified in the flowchart and/or block diagram block or blocks.

The computer readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various aspects of the inventive arrangements. In this regard, each block in the flowcharts or block diagrams may represent a module, segment, or portion of instructions, which comprises one or more executable instructions for implementing the specified operations. In some alternative implementations, the operations noted in the blocks may occur out of the order noted in the figures. For example, two blocks shown in succession may be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts or carry out combinations of special purpose hardware and computer instructions.

The corresponding structures, materials, acts, and equivalents of all means or step plus function elements that may be found in the claims below are intended to include any structure, material, or act for performing the function in combination with other claimed elements as specifically claimed.

Modifications and variations may be apparent to those of ordinary skill in the art without departing from the scope and spirit of the described inventive arrangements. Accordingly, reference should be made to the following claims, rather than to the foregoing disclosure, as indicating the scope of such features and implementations.

What is claimed is:

1. An apparatus comprising:
a dryer comprising a dryer drum configured to receive laundry items to be dried during a drying cycle;
a desiccant reservoir comprising a desiccant configured to remove moisture in air from the dryer drum during the drying cycle; and
a heat pump configured to regenerate the desiccant in the desiccant reservoir for use during a subsequent drying cycle, wherein the heat pump comprises a condenser configured to condense a refrigerant, an evaporator configured to evaporate the condensed refrigerant, and a compressor configured to compress the evaporated refrigerant and provide the compressed refrigerant to the condenser.

2. The apparatus of claim 1, wherein the heat pump further comprises a secondary heat pump loop, the secondary heat pump loop comprising (i) a secondary condenser coupled to the compressor using a first three-way valve and (ii) a secondary evaporator coupled to the compressor using a second three-way valve.

3. The apparatus of claim 2, wherein:
during the drying cycle, (i) the first three-way valve is configured to couple the condenser and the secondary condenser and (ii) the second three-way valve is configured to couple the evaporator and the secondary evaporator; and
during the regeneration of the desiccant in the desiccant reservoir, (i) the first three-way valve is configured to couple the compressor and the condenser and (ii) the second three-way valve is configured to couple the compressor and the evaporator.

3. The apparatus of claim 3, wherein:
the secondary condenser is configured to increase an inlet temperature to the dryer drum during the drying cycle; and
the secondary evaporator is configured to decrease a temperature of the desiccant reservoir during the drying cycle.

5. The apparatus of claim 1, further comprising:
a first fan configured to direct air from the desiccant reservoir into the dryer drum during the drying cycle; and
a second fan configured to direct air from the heat pump into the desiccant reservoir during the regeneration of the desiccant in the desiccant reservoir;
wherein the first fan is configured to be turned off during the regeneration of the desiccant in the desiccant reservoir; and
wherein the second fan is configured to be turned off during the drying cycle.

6. The apparatus of claim 1, wherein the heat pump is configured to at least partially regenerate the desiccant in the desiccant reservoir after the drying cycle ends and before the subsequent drying cycle begins.

7. The apparatus of claim 1, wherein the heat pump has a. coefficient of performance of at least two.

8. An apparatus comprising:
a dryer comprising a dryer drum configured to receive laundry items to be dried during a drying cycle;
a desiccant reservoir comprising a desiccant configured to remove moisture in air from the dryer drum during the drying cycle; and
a first fan configured to direct ambient or outdoor air over or through the desiccant in the desiccant reservoir to regenerate the desiccant in the desiccant reservoir for use during a subsequent drying cycle.

9. The apparatus of claim 8, wherein the desiccant reservoir and the first fan are positioned in a base of the dryer.

10. The apparatus of claim 8, further comprising:
a heater configured to heat the ambient or outdoor air, wherein the desiccant reservoir is configured to receive the heated air.

11. The apparatus of claim 10, wherein:
during the drying cycle, the heater is configured to not heat the ambient or outdoor air;
during a first portion of the regeneration of the desiccant in the desiccant reservoir, the heater is configured to not heat the ambient or outdoor air; and
during a second portion of the regeneration of the desiccant in the desiccant reservoir, the heater is configured to heat the ambient or outdoor air.

12. The apparatus of claim 8, further comprising:
a second fan configured to direct air from the desiccant reservoir into the dryer drum during the drying cycle.

13. The apparatus of claim 12, wherein:
the first fan is configured to be turned off during the drying cycle; and
the second fan is configured to be turned off during the regeneration of the desiccant in the desiccant reservoir.

14. An apparatus comprising:
a dryer comprising a dryer drum configured to receive laundry items to be dried during a drying cycle;
a desiccant reservoir comprising a desiccant configured to remove moisture in air from the dryer drum during the drying cycle; and
a ventilation line coupled to the desiccant reservoir and configured to be coupled to an external appliance, the ventilation line configured to transport heated air from the desiccant reservoir to the external appliance for use during regeneration of the desiccant in the desiccant reservoir.

15. The apparatus of claim 14, wherein the ventilation line is configured to be coupled to a washing machine such that the heated air is able to heat water in the washing machine.

16. The apparatus of claim 14, wherein the ventilation line is configured to be coupled to a heat exchanger associated with one of: a hot water tank, a dishwasher, or a washing machine.

17. The apparatus of claim 14, further comprising:
a fan configured to direct ambient or outdoor air over or through the desiccant in the desiccant reservoir to regenerate the desiccant in the desiccant reservoir for use during a subsequent drying cycle.

18. The apparatus of claim 14, further comprising:
a fan configured to direct the heated air from the desiccant reservoir to the external appliance.

19. The apparatus of claim 14, further comprising:
a heater configured to heat air from the external appliance, wherein the desiccant reservoir is configured to receive the heated air.

20. The apparatus of claim 19, wherein:
during the drying cycle, the heater is configured to not heat the air from the external appliance;
during a first portion of the regeneration of the desiccant in the desiccant reservoir, the heater is configured to not heat the air from the external appliance; and
during a second portion of the regeneration of the desiccant in the desiccant reservoir, the heater is configured to heat the air from the external appliance.
